(19) United States
(12) Patent Application Publication
(10) Pub. No.: US 2019/0017222 A1
(43) Pub. Date: Jan. 17, 2019

(54) COMPOSITES FOR CURED-IN-PLACE PIPE

(71) Applicant: Dow Global Technologies LLC, Midland, MI (US)

(72) Inventors: Dane Chang, Sugar Land, TX (US); Robbyn Prange, Midland, MI (US); Daniel L. Dermody, Midland, MI (US); David L. Malotky, Midland, MI (US); Matthew J. Crimmins, Midland, MI (US)

(73) Assignee: Dow Global Technologies LLC, Midland, MI (US)

(21) Appl. No.: 16/067,205

(22) PCT Filed: Dec. 16, 2016
(86) PCT No.: PCT/US2016/067124

§ 371 Date: Jun. 29, 2018

Related U.S. Application Data
(60) Provisional application No. 62/275,024, filed on Jan. 5, 2016.

(51) Int. Cl. D06N 3/18; D06N 3/04; B29C 63/36; F16L 55/165

(52) U.S. Cl. CPC D06N 3/186; D06N 3/045; B32B 5/26; F16L 55/1656; B29C 63/36

(57) ABSTRACT

Embodiments of the present disclosure include flexible impregnated articles, composites produced by curing such flexible impregnated article, and processes for forming flexible impregnated articles. The flexible impregnated articles, composites, and processes can be used as alternatives to articles, composites, and processes in a cured-in-place pipe rehabilitation process that include epoxy resins, thus eliminating toxicity issues associated with the use of epoxy resins. The instantly-disclosed flexible impregnated articles, composites, and processes can be particularly useful for the CIPP process in potable water pipe and pressure pipe applications.

### CROSS-REFERENCE TO RELATED APPLICATIONS

This application claims priority to U.S. Patent Application Ser. No. 62/275,024, filed Jan. 5, 2016, the contents of which are hereby incorporated by reference in their entirety.

### TECHNICAL FIELD

Embodiments described herein relate generally to flexible impregnated articles, composites produced by heating such flexible impregnated articles, and processes for forming flexible impregnated articles. Such flexible impregnated articles, composites, and processes can be used as alternatives to articles, composites, and processes in a cured-in-place pipe rehabilitation process that include epoxy resins, thus eliminating toxicity issues associated with the use of epoxy resins.

### BACKGROUND

Underground sewer pipes, potable water pipes, and other pipes fracture with use and age. Repair of these leaking and damaged pipes is time consuming and expensive as it involves excavation and replacement of these damaged pipes. Cured-in-place pipe (CIPP) technology was first utilized in the United Kingdom in 1971, and introduced to the North American market in the late 1970's. Over the next 20 years, this technology revolutionized the sewer pipeline repair industry, providing a reliable solution to rehabilitating sewer pipelines without the need to excavate. There are two used processes for cured-in-place pipe applications: “Inversion Installation Method” and “Pull-in Installation Method”. The most common is the “Inversion Installation Method” and the process involves impregnating a flexible non-woven felt liner with a curable thermoset composition, followed by inverting the impregnated non-woven felt liner into an existing (host) pipe, and curing of the impregnated felt liner within the host pipe by application of hot water, UV light, or steam. The CIPP process is classified as rehabilitation or renovation, because it forms a new jointless, seamless, and hard inner pipe within and adhering to the existing host pipe.

Epoxy resin thermoset systems are typically used in producing potable water pipe and pressure pipe applications. Currently, the most common CIPP process for producing potable water pipes and pressure pipes involves inverting an epoxy resin-saturated felt tube made of polyester, fiberglass cloth, or a number of other materials suitable for resin impregnation, into a damaged host pipe. The epoxy resin-saturated felt tube has a polyolefin coating on the other side. Typically, the polyolefin coating thickness is between 20-35 mils. Sometimes, the polyolefin coating leaks during the pressure inverting process. If the polyolefin coating leaks during a potable water pipeline rehabilitation process, the epoxy resin leaks through the coating. This results in water contamination, violations of NSF Standard 61 requirements, and requires expensive repair.

Accordingly, there may be a need for alternatives to epoxy resin thermoset systems for the CIPP process. Such alternatives would eliminate toxicity issues associated with epoxy, while maintaining viscosity and cure profiles of traditionally used resins to allow for impregnation, inversion, and curing of the CIPP liners. Such alternatives would be particularly useful for the CIPP process in potable water pipe and pressure pipe applications.

### SUMMARY

Embodiments of the present disclosure meet those needs by providing flexible impregnated articles, composites produced by curing such flexible impregnated article, and processes for forming flexible impregnated articles. The flexible impregnated articles, composites, and processes can be used as alternatives to articles, composites, and processes in a cured-in-place pipe rehabilitation process that include epoxy resins, thus eliminating toxicity issues associated with the use of epoxy resins. The instantly-disclosed flexible impregnated articles, composites, and processes can be particularly useful for the CIPP process in potable water pipe and pressure pipe applications.

According to one embodiment of the present disclosure, a flexible impregnated article is provided. The flexible impregnated article includes a fabric material comprising a thermoplastic backing layer and a fibrous layer impregnated with an aqueous dispersion. The aqueous dispersion comprises (a) a base resin comprising at least one C₂-C₃ polyolefin having a melting point of at least 110° C., and (b) a dispersing agent comprising at least one polymer having ethylene and carboxylic acid or a modifying polymer comprising at least one maleated C₂-C₃ polyolefin wax, and combinations. The flexible impregnated article has a flexural modulus of less than 15,000 psi.

According to a further embodiment of the invention, a composite produced by heating a flexible impregnated article is provided. The flexible impregnated article includes a fabric material comprising a thermoplastic backing layer and a fibrous layer impregnated with an aqueous dispersion. The flexible impregnated article has a flexural modulus of less than 15,000 psi. The aqueous dispersion comprises (a) a base resin comprising at least one C₂-C₃ polyolefin having a melting point of at least 110° C., and (b) a dispersing agent comprising at least one polymer having ethylene and carboxylic acid or a modifying polymer comprising at least one maleated C₂-C₃ polyolefin wax, and combinations. The flexible impregnated article is heated above the melting temperature of the base resin of the aqueous dispersion.

In yet another embodiment, a process for forming flexible impregnated article is provided. The process comprises providing a fabric material comprising a thermoplastic backing layer and a fibrous layer, exposing the fabric material to an aqueous dispersion, and drying the aqueous dispersion to impregnate the fibrous layer. The aqueous dispersion comprises (a) a base resin comprising at least one C₂-C₃ polyolefin having a melting point of at least 110° C., and (b) a dispersing agent comprising at least one of a polymer having ethylene and carboxylic acid, a modifying polymer comprising at least one maleated C₂-C₃ polyolefin wax, and combinations thereof.

It is to be understood that both the foregoing general description and the following detailed description describe various embodiments and are intended to provide an overview or framework for understanding the nature and character of the claimed subject matter. The accompanying drawings are included to provide a further understanding of the various embodiments, and are incorporated into and constitute a part of this specification. The drawings illustrate the various embodiments described herein, and together with the description serve to explain the principles and operations of the claimed subject matter.

### DETAILED DESCRIPTION

Reference will now be made in detail to various embodiments of the instantly-disclosed flexible impregnated articles, composites produced by curing such flexible impregnated articles, and processes for forming flexible impregnated articles. The flexible impregnated articles, composites, and processes can be used as alternatives to articles, composites, and processes that include epoxy resins in a CIPP rehabilitation process, thus eliminating toxicity issues associated with the use of epoxy resins. The flexible impregnated articles, composites, and processes can be particularly useful for the CIPP process in potable water and pressure pipe applications.

Unless otherwise indicated, the disclosure of any ranges in the specification and claims are to be understood as including the range itself and also anything subsumed therein, as well as endpoints. Ranges can be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

As used herein, the singular forms “a,” “an” and “the” include plural referents unless the context clearly dictates otherwise. Thus, for example, reference to “a” component includes aspects having two or more such components, unless the context clearly indicates otherwise.

In various embodiments, a flexible impregnated article is provided. The flexible impregnated article includes a fabric material comprising a thermoplastic backing layer and a fibrous layer impregnated with an aqueous dispersion. In some embodiments, the aqueous dispersion comprises (a) a base resin comprising at least one C₂-C₃ polyolefin having a melting point of at least 110° C., and (b) a dispersing agent comprising at least one polymer having ethylene and carboxylic acid or a modifying polymer comprising at least one maleated C₂-C₃ polyolefin wax, and combinations. In certain embodiments, the flexible impregnated article can have a flexural modulus of less than 15,000 psi. In certain embodiments, the flexible impregnated article is substantially free of epoxy and carbamide material.

The thermoplastic backing layer of the fabric material can comprise any thermoplastic that is suitable for the CIPP process. The thermoplastic backing layer can include, but is not limited to, polyolefins (e.g. polyethylene, polypropylene), polystyrene, polyamides (e.g., nylons), polyimides such as thermoplastic polyimides, polypropylene oxide, polyphenylene oxide, acrylonitrile-butadiene-styrene (ABS), polyacetals, polyesters, polyphenoxies, polyacrylic esters, polyvinyl esters, polyvinyl halides, polysiloxanes, polyurethanes, polyethers, polysulfides, polycarbonates, polybutylenes polyarylates, acrylic polymers, cellulosics, fluoroplastics, polyketones and ketone based resins (e.g. PEK, PEEK, PEKEKK), nitrile-based polymers, polymethyl pentenes, polyphenylene sulfides (PPS), polypthalamides, polysulfones, polyethersulfones (PES), polyinylidene chlorides, polyvinyl chlorides (PVC), ethylene-vinyl acetate copolymers (EVA), high impact polystyrene (HIPS), acrylonitrile-styrene-acrylic ester copolymers (ASA) and styrene-acrylonitrile copolymers (SAN). In certain embodiments, thermoplastic backing layer of the fabric material can comprise a base resin comprising at least one C₂-C₃ polyolefin having a melting point of at least 110° C. The at least one C₂-C₃ polyolefin can include polyolefins such as polypropylene, polyethylene, copolymers thereof, and blends thereof, as well as ethylene-propylene-diene terpolymers, may be used. In some embodiments, exemplary C₂-C₃ polyolefin include homogeneous polymers; high density polyethylene (HDPE); medium density polyethylene (MDPE); heterogeneously branched linear low density polyethylene (LLDPE); heterogeneously branched ultra low linear density polyethylene (ULDPE); homogeneously branched, linear ethylene/alpha-olefin copolymers; homogeneously branched, substantially linear ethylene/alpha-olefin polymers; and high pressure, free radical polymerized ethylene polymers and copolymers such as low density polyethylene (LDPE) or ethylene vinyl acetate polymers (EVA). In some embodiments, the polyethylene copolymers have a density from above about 0.930 g/cm³. In other embodiments, the polyethylene copolymers have a density from about 0.930 g/cm³ to about 0.970 g/cm³. In certain embodiments, the thermoplastic backing layer of the fabric material can comprise polypropylene. Additionally, the thermoplastic backing layer of the fabric material can comprise polypropylne, random copolymer with ethen (1-propene, polymer with ethane), with a melt index of 35 g/10 min when measured at 230° C./2.16 kg, a denisty of 0.90 g/cm³, as described in Dow TDS and MSDS for 6D43 polypropylene. Various commercially available C₂-C₃ polyolefins are contemplated for the thermoplastic backing layer of the fabric material. C₂-C₃ polyolefins suitable for use may include, by way of example and not limitation, HDPE DMDA 8940 and HDPE DGDA 2420, both available from The Dow Chemical Company, Midland Mich.

The fibers of the fibrous layer may be of any material and in any form that is suitable for the CIPP process. For the CIPP process, the fibrous layer is typically a non-woven felt, fiber glass reinforced non-woven felt, or glass fiber. The fibers may also include: short fibers, long fibers, non-woven fibers, woven fibers, or any combination thereof. The fibers may be unidirectional fibers. The fibers may be oriented in a plurality of directions. For example, one fiber may be oriented in a first direction and a second fiber may be oriented in a second direction having a predetermined angle from the first direction. The fibers may be randomly oriented in two or more dimensions. For example, the fibers may be randomly oriented short fibers. The fibers may include organic fibers, inorganic fibers, or both. In certain embodiments, the fibers can be in the form of a felt. The fibers can be a non-woven felt or a fiber glass reinforced non-woven felt. Examples of fibers that can be used in the fibrous layer include glass, carbon, graphite, polyaramid, nylon, polyester, polypropylene, polyethylene. Natural fibers include flax, hemp, jute, ramie, kenaf, coir, bamboo, agave, sisal, cotton, abaca, manila hemp, and henequen. In some embodiments, the fibrous layer comprises fiber glass. In some embodiments, the fibrous layer comprises prepeg fiber.

In some embodiments, the aqueous dispersion of the present disclosure includes a base resin comprising at least one C₂-C₃ polyolefin having a melting point of at least 110° C. The at least one C₂-C₃ polyolefin can include polyolefins such as polypropylene, polyethylene, copolymers thereof, and blends thereof, as well as ethylene-propylene-diene terpolymers, may be used. In some embodiments, exemplary C₂-C₃ polyolefin include homogeneous polymers; high density polyethylene (HDPE); medium density polyethylene (MDPE); heterogeneously branched linear low density polyethylene (LLDPE); heterogeneously branched ultra low linear density polyethylene (ULDPE); homogeneously branched, linear ethylene/alpha-olefin copolymers; homogeneously branched, substantially linear ethylene/alpha-olefin polymers; and high pressure, free radical polymerized ethylene polymers and copolymers such as low density polyethylene (LDPE) or ethylene vinyl acetate polymers (EVA). In some embodiments, the polyethylene copolymers have a density from above about 0.930 g/cm³. In other embodiments, the polyethylene copolymers have a density from about 0.930 g/cm³ to about 0.970 g/cm³. In certain embodiments, the base resin comprises polypropylene. Various commercially available C₂-C₃ polyolefins are contemplated for the aqueous dispersion. C₂-C₃ polyolefins suitable for use may include, by way of example and not limitation, HDPE DMDA 8940, HDPE DGDA 2420, and 6D43 polypropylene, all available from The Dow Chemical Company, Midland Mich. In certain embodiments, the C₂-C₃ polyolefin has a melting point of at least 110° C. In some embodiments, the base resin may be included in an amount from about 60 weight % to about 90 weight % based on a weight of the aqueous dispersion. In other embodiments, the base resin may be included in an amount from about 65 weight % to about 85 weight % or from about 70 weight % to about 80 weight % based on a weight of the aqueous dispersion.

In some embodiments, the aqueous dispersion of the present disclosure also includes a dispersing agent comprising at least one polymer having ethylene and carboxylic acid, a modifying polymer comprising at least one maleated C₂-C₃ polyolefin wax, or combinations thereof.

In certain embodiments, the dispersing agent comprises at least one polymer having ethylene and carboxylic acid. The stability of the aqueous dispersion is enhanced by the addition of the dispersing agent. Various commercially available dispersing agents comprising at least one polymer having ethylene and carboxylic acid are contemplated for the aqueous dispersion. Dispersing agents comprising ethylene and carboxylic acid copolymers suitable for use may include, by way of example and not limitation, PRIMACOR™ 5980i, available from The Dow Chemical Company, Midland Mich., and UNICID™ 350, available from Barker Hughes Corporation. In some embodiments, the dispersing agent may be included in an amount from about 3 weight % to about 30 weight % based on a weight of the aqueous dispersion. In other embodiments, the dispersing agent may be included in an amount from about 5 weight % to about 25 weight % or from about 10 weight % to about 20 weight % based on a weight of the aqueous dispersion. In certain embodiments, PRIMACOR™ 5980i may be included in an amount from about 10 weight % to about 30 weight % based on a weight of the aqueous dispersion, while UNICID™ 350 may be included in an amount from about 3 weight % to about 8 weight % based on total weight of the aqueous dispersion.

In certain embodiments, the aqueous dispersion includes the modifying polymer comprising at least one maleated C₂-C₃ polyolefin wax. The mechanical properties of the aqueous dispersion can be improved by the addition of the modifying polymer. The modifying polymer can also improve dispersion of the base resin and improve adhesion of the aqueous dispersion to the fibrous layer of the fabric material. The modifying polymer comprising at least one maleated C₂-C₃ polyolefin wax can include polyolefins such as polypropylene, polyethylene, copolymers thereof, and blends thereof, as well as ethylene-propylene-diene terpolymers, may be used. In some embodiments, exemplary C₂-C₃ polyolefin include homogeneous polymers; high density polyethylene (HDPE); heterogeneously branched linear low density polyethylene (LLDPE); heterogeneously branched ultra low linear density polyethylene (ULDPE); homogeneously branched, linear ethylene/alpha-olefin copolymers; homogeneously branched, substantially linear ethylene/alpha-olefin polymers; and high pressure, free radical polymerized ethylene polymers and copolymers such as low density polyethylene (LDPE) or ethylene vinyl acetate polymers (EVA). Various commercially available modifying polymers comprising at least one maleated C₂-C₃ polyolefin wax are contemplated for the aqueous dispersion. Maleated C₂-C₃ polyolefin wax suitable for use may include, by way of example and not limitation, AMPLIFY™ GR204 (available from The Dow Chemical Company, Midland Mich.), LICOCENE™PE MA 4351, LICOCENE™ 6452 (both available from Clariant), and Honeywell AC575 (available from Honeywell Performance Materials and Technologies). In some embodiments, the modifying polymer may be included in an amount from about 0 weight % to about 30 weight % based on a weight of the aqueous dispersion. In other embodiments, the modifying polymer may be included in an amount from about 5 weight % to about 25 weight % or from about 10 weight % to about 20 weight % based on a weight of the aqueous dispersion.

In some embodiments, the aqueous dispersion of the present disclosure also includes a cross linker. Various commercially available cross-linkers are contemplated for the aqueous dispersion. A suitable cross-linker for dispersions cured at 140° C. use may include, by way of example and not limitation, Primid™ QM-1260 (beta-hydroxyl alky amide), available from EMS-Griltech. In certain embodiments of the aqueous dispersion that include Primid™ QM-1260, a loading level can range from about 0.124 grams/10 grams of polymer to about 0.25 grams/10 grams of polymer. A suitable cross-linker for dispersions cured at 120° C. may include, by way of example and not limitation, Cymel™ 303 (hexamethoxymethylmelamine), available from CYTEC Industries. In certain embodiments of the aqueous dispersion that include Cymel™ 303, a loading level can range from about 0.47 grams/10 grams of polymer to about 0.95 grams/10 grams of polymer. For embodiments of the aqueous dispersion that include Cymel™ 303, Nacure™ 5925 (amine neutralized alkylbenzene sulfonic acid, available from King Industries) can be used as the catalyst. In certain embodiments, the loading level of Nacure™ 5925 can range from about 0.02 grams/10 grams of polymer to about 0.04 grams/10 grams of polymer.

The aqueous dispersion may be made by any convenient method suitable for providing an aqueous dispersion of particles having one or more features according to the instant disclosure. Preferred processes result in dispersion particles that are sufficiently small so that they can flow enter and/or flow through the spaces formed between the fibers of the fibrous layer, such as non-woven felt, fiber glass reinforced non-woven felt, or glass fiber typically used in the CIPP process. For example, the base resin, and modifying polymer and/or dispersing agent can be melt-kneaded in an extruder along with water and a neutralizing agent, such as dimethyethanolamine (DMEA) to form a dispersion compound. In certain embodiments, other neutralizing agents such as KOH, NaOH, and other fugitive bases such as ammonia and 2-amino-2-methyl1-propanol (AMP) may be used.

Any melt-kneading means known in the art may be used. In some embodiments, a kneader, a BANBURY® mixer, single-screw extruder, or a multi-screw extruder is used. A process for producing the dispersions in accordance with the present invention is not particularly limited. One preferred process, for example, is a process comprising melt-kneading the above-mentioned components according to U.S. Pat. No. 5,756,659 and U.S. Pat. No. 6,455,636. The aqueous dispersion may also be prepared using one or any combination of steps described in U.S. Pat. No. 5,539,021, U.S. Pat. Nos. 5,688,842, and 8,063,128, and US2005/0100754A1.

In some embodiments, a polyolefin dispersion or dispersion compound may be applied to a fibrous structure using any application method known to those skilled in the art. In other embodiments, a fibrous structure may be impregnated with a polyolefin dispersion or dispersion compound. Advantageously, the aqueous dispersions formed in accordance with the embodiments disclosed herein provide the ability to apply the aqueous dispersion to or to impregnate the dispersion into fibers of the fibrous layer, such as non-woven felt, fiber glass reinforced non-woven felt, or glass fiber typically used in the CIPP process. The aqueous dispersion achieves good adhesive properties, and allows for the formation of a flexible impregnated article upon drying.

The aqueous dispersion includes a sufficient amount of the water so that the dispersion can flow. The flow characteristics of the aqueous dispersion can be controlled by adjusting the water concentration. The concentration of the water in the aqueous dispersion may vary from about 30 weight percent, to about 60 weight percent or more, based on the total weight of the aqueous dispersion. The concentration of the water in the aqueous dispersion can be sufficiently low so that the aqueous dispersion can be easily dried in one or more drying steps, such as a drying step that employs an elevated temperature (e.g., a temperature of about 35° C. or more), that employs a reduce pressure (e.g., a pressure of about 0.5 atmospheres or less), or both. The concentration of the water in the aqueous dispersion may be about 85 weight percent or less, about 75 weight percent or less about 65 weight percent or less, about 55 weight percent or less, about 50 weight percent or less, or about 45 weight percent or less, based on the total weight of the aqueous dispersion. Aqueous dispersions having a concentration of water of about 45 weight percent or less allow for reduced drying times, and/or reduced energy costs of drying.

The aqueous dispersion of the instant disclosure impregnates gaps between individual fibers of the fibrous layer of the fabric material, such as non-woven felt, fiber glass reinforced non-woven felt, or glass fiber typically used in the CIPP process. The particles of the aqueous dispersion can be maintained in suspension even when adhered to an individual fiber. The particles of the aqueous dispersion can be of sufficient size and mobility to penetrate the fibers of the fibrous layer and substantially fill the gaps between individual fibers. The aqueous dispersions of the present disclosure can be characterized in having an average particle size of between about 0.4 to about 40.0 microns. By “average particle size”, the present invention means the volume-mean particle size. In order to measure the particle size, laser-diffraction techniques may be employed for example. A particle size in this description refers to the diameter of the polymer in the dispersion. For polymer particles that are not spherical, the diameter of the particle is the average of the long and short axes of the particle. Particle sizes can be measured, for example, on a Beckman-Coulter LS230 laser-diffraction particle size analyzer or other suitable device.

The aqueous dispersion may include a total solids content (base resin, and dispersing agent and/or modifying polymer) from about 40 weight percent to about 65 weight percent or more, based on the total weight of the aqueous dispersion. The concentration of the total solids content in the aqueous dispersion may be about 85 weight percent or less, about 75 weight percent or less, about 65 weight percent or less, about 55 weight percent or less, about 50 weight percent or less, or about 45 weight percent or less, based on the total weight of the aqueous dispersion. The concentration of the total solids content in the aqueous dispersion may be about 10 weight percent or more, about 25 weight percent or more, or about 45 weight percent or more, based on the total weight of the aqueous dispersion. The total solids content of the aqueous dispersion should be as high as possible while still providing the necessary viscosity needed to form the flexible impregnated article. The aqueous dispersions have a sufficiently low viscosity so that they can flow into architecture of fibers of the fibrous layer, but a sufficiently high amount of solids so that the particles are not too dispersed once the water and neutralizing agent (if present) are removed by drying. For example, the dispersion can have a viscosity (at 25° C.) of less than about 1,000 cps.

The aqueous dispersion of the present disclosure allows the individual fibers to be impregnated with particles of the aqueous in the absence of high pressures. The fibrous layer can be exposed to the aqueous dispersion in any manner that “wets” the fibers with a sufficient amount of the aqueous dispersion. The exposing can occur by immersing or dipping the fibrous layer in the aqueous dispersion, spraying the fibrous layer with the aqueous dispersion, painting the fibrous layer, or any other wetting means. Because the particles in the aqueous dispersion have sufficiently small particle size, simply exposing the fibrous layer to the aqueous dispersion allows particles to impregnate the gaps between individual fibers.

The penetration can occur to the extent that polymer particles substantially fill gaps between the individual fibers of the fibrous layer, such as non-woven felt, fiber glass reinforced non-woven felt, or glass fiber typically used in the CIPP process. “Substantially fill gaps” refers to at least about 90%, at least about 95%, and even at least about 99% of a gap between individual fibers is filled with polymer particles. In one embodiment, substantially each fiber in the fibrous layer is coated with polymer particles, and gaps between substantially each fiber in the fibrous layer is substantially filled with polymer particles. However, each and every fiber in the fibrous layer may not be coated and completely impregnated by particles of a polymer, and thus “substantially each fiber in the strand” can refer to coating at least 50% of the fibers, at least 80% of the fibers are individually coated by particles, at least 90% of the fibers are individually coated by particles, at least 95% of the fibers are individually coated by particles, and even at least about 99% of the fibers are individually coated by particles.

In certain embodiments, the aqueous dispersion is impregnated into the fibrous layer at a coat weight of less than about 0.3 g/cm² of fibrous material. In other embodiments, the aqueous dispersion is impregnated into the fibrous layer at a coat weight from about 0.3 g/cm² to about 0.10 g/cm² of fibrous material. In some embodiments, the aqueous dispersion is impregnated into the fibrous layer at a coat weight from about 0.25 g/cm² to about 0.15 g/cm² of fibrous material. In other embodiments, the aqueous dispersion is impregnated into the fibrous layer at a coat weight of less than about 0.2 g/cm² of fibrous material, or less than about 0.15 g/cm² of fibrous material. However, the amount or degree to which a fibrous layer is impregnated with the aqueous dispersion can be controlled. For example, impregnation can be controlled by pressing the fabric between calenders, removing excess material. Impregnation can additionally be controlled, for example, by adjusting one or more of the viscosity of the aqueous dispersion, the concentration of the solid components in the aqueous dispersion, or the polarity of the aqueous dispersion. A desirable degree or amount of impregnation can range from a partial saturation of the fibrous structure to a complete saturation of the fibrous structure. The desired degree of impregnation can depend upon variables including the nature of the fiber being impregnated and the nature of impregnated material. The intended end properties of the impregnated structure will influence the selection of the specific ingredients and processing parameters.

Once the particles have been dispersed throughout the fibrous layer of the fabric material, the wet fibrous layer is dried to form the flexible impregnated article. In some embodiments, the flexible impregnated article has a flexural modulus of less than about 15,000 psi. The flexural properties can be determined using method ASTM D 790. The step of drying the fibrous layer removes some or all of the water as well as the neutralizing agent (if present). For example, the wet fibrous layer may be dried by heating the wet fibrous layer, by air-drying the wet fibrous layer, by flowing a dry purge gas over the wet fibrous layer, by placing the fibrous wet layer in a desicattor or other low humidity environment, by using a vacuum, or any combination thereof. In certain embodiments, the drying step results in substantially none of the base resin being removed, substantially none of the dispersing agent and/or modifying polymer is removed, or any combination thereof.

The drying step(s) may remove excess water and/or the neutralizing agent. In certain embodiments, the drying step(s) removes substantially all of the water in the fibrous layer with the applied aqueous dispersion. For example, the drying step(s) may reduce the amount of water to about 2 weight percent or less, about 1 weight percent or less, about 0.5 weight percent or less, about 0.2 weight percent or less, and about 0.1 weight percent or less. In some embodiments, the flexible impregnated article is about 100% solids.

In some embodiments, the drying step(s) comprises applying an elevated temperature that is less than the minimum film forming temperature of the base resin, modifying polymer, and dispersing agent of the aqueous dispersion. Thus, the drying step(s) allows for the removal of excess water and/or neutralizing agent while maintaining the particles inside the fibrous layer. Drying below the minimum film forming temperature of the base resin, modifying polymer, and dispersing agent of the aqueous dispersion allows for the formation of a flexible, impregnated article in which the particles of the aqueous dispersion are not fused or cured. Unlike the prior art, drying the fibrous layer with the applied aqueous dispersion below the minimum film-forming temperature does not result in a powder that can be easily lost or sloughed off from the fibrous layer.

In some embodiments, a composite is produced by heating the flexible impregnated article above the melting temperature of the aqueous dispersion base resin. Heating the flexible impregnated article above the melting temperature of the aqueous dispersion base resin results in coalescence of the base resin particles, forming a rigid structure. In some embodiments, the weight does not change between the flexible impregnated article and the composite formed by heating the flexible impregnated article. The flexibility of the article is lost, and the resulting composite becomes structural with the desired strength and modulus. In some embodiments, the composite has a flexural modulus at least 2.3 times the flexural modulus of the flexible impregnated article. In certain embodiments, the composite has a flexural modulus at least about 3 times the flexural modulus of the flexible impregnated article.

The presently disclosed flexible impregnated articles, composites produced by heating such flexible impregnated articles, and processes for forming flexible impregnated articles can be used in a cured-in-place pipe rehabilitation process. As previously mentioned, there are two process used for cured-in-place pipe application: “Inversion Installation Method” and “Pull-in Installation Method”. The first process of lining the pipe is described in detail in method ASTM F 1216: “Standard practice for Rehabilitation of Existing Pipelines and Conduits by the Inversion and Curing of a Resin-Impregnated Tube,” which is herein incorporated by reference. The second method of lining the pipe is described in detail in method ASTM F 1743: “Standard Practice for Rehabilitation of Existing Pipelines and Conduits by Pulled-in-Place Installation of Cured-in-Place Thermosetting Resin Pipe” or ASTM F2019: “Standard Practice for Rehabilitation of Existing Pipelines and Conduits by the Pulled-in-Place Installation of Glass Reinforced Plastic (GRP) Cured-in-Place Thermosetting Resin Pipe” (CIPP).

The inversion installation method process includes impregnating the fibrous layer (e.g. a non-woven felt) of the fabric material (e.g. a liner, such as a laminate of non-woven felt coated with a thermoplastic sheet material) with the presently disclosed aqueous dispersion, drying the impregnated fibrous layer of fabric material at a temperature below the minimum film forming temperature of base resin and dispersing agent and/or modifying polymer of the aqueous dispersion to form a flexible impregnated article, inverting the impregnated flexible article (e.g. a liner) into a host pipe, and heating the article which is now in an existing pipe to a temperature above the melting temperature of the base resin. The aqueous dispersion for repair of pipes has to properly wet the fibrous layer of the article (e.g. liner). As previously described, the fibrous material of the liner can be non-woven felt or a fiber glass reinforced non-woven felt, or glass fiber reinforced liners. The non-woven felt liner is impregnated with the aqueous dispersion at room temperature. The felt liner thickness is generally in the range of from about 3 mm to about 25 mm. The infusion is generally done at room temperature between about 20° C. to about 30° C. The felt liner is stitched in cylindrical form (the shape of the host pipe) and is made to fit snugly in the host pipe. The diameter of the liner can be from about 3 inches to about 100 inches. The amount of the aqueous dispersion used to infuse the felt liner depends on the host pipe diameter and the felt thickness.

The general range for aqueous dispersion usage is about 1 lb per linear foot to about 50 pound per linear foot. The impregnated liner is inverted inside out along the pipe using fluid pressure bringing the flexible impregnated article now in contact with the host pipe. When the flexible impregnated liner is heated above the melting temperature of the base resin, the flexible impregnated liner forms a composite, such as a rigid shell inside the host pipe, resulting in a smooth new inner surface. For the CIPP process, the flexible impregnated liner is usually heated above the melting temperature of the base resin using hot water or high pressured steam.

There are minimum flexural modulus and flexural strength requirements for CIPP applications. The flexural properties are determined using method ASTM D 790. In some instances depending on the end use application, it is necessary for the coalesced/fused composite to withstand chemical reagents. The chemical resistance test is done following method ASTM D 543. The method evaluates change in weight and retention of flexural properties in the presence of chemical reagents.

In order that various embodiments may be more readily understood, reference is made to the following examples which are intended to illustrate various embodiments, but do not limit the scope thereof.

### EXAMPLE 1

### Polyolefin Aqueous Dispersion Synthesis

Aqueous dispersions examples A-E having compositions as disclosed in Tables 2A-2B, were formed from raw materials disclosed in Table 1. Using the conditions as described in Tables 2A-2B, aqueous dispersion examples A-E were prepared using the following general procedure. Components 1 to 3 listed in Tables 2A-2B, were fed into a 25 mm diameter twin screw extruder using a controlled rate feeder; using the feed rate in grams/minute (g/min) as indicated in Table 2B. Components 1 to 3 were forwarded through the extruder and melted to form a liquid melt material.

The extruder temperature profile was ramped up to the temperature listed in the “Polymer Melt Zone” column of Table 2B. Water and volatile base and/or neutralizing agent were mixed together and fed to the extruder at a rate indicated in Table I for neutralization at an initial water introduction site. Then dilution water was fed into the extruder in one or two locations (1^{st} and 2^{nd} locations) via two separate pumps at the rates indicated in Table 2A. The extruder temperature profile was cooled back down to a temperature below 100° C. near the end of the extruder. The extruder speed was around 470 rpm in most cases as recorded in Table 2B. At the extruder outlet, a backpressure regulator was used to adjust the pressure inside the extruder barrel to a pressure adapted to reduce steam formation (generally, the pressure was from 2 MPa to 4 MPa).

Each aqueous dispersion exited from the extruder and was filtered through a 200 micrometer (μm) filter. The resultant filtered aqueous dispersions had a solids content measured in weight percent (wt %), and the solids particles of the dispersion had a volume mean particle size measured in microns and recorded in Table 2B. The solids content of the aqueous dispersion was measured using an infrared solids analyzer; and the particle size of the solids particles of the aqueous dispersion was measured using a COULTER™ LS-230 particle size analyzer (Beckman Coulter Corporation, Brea, Calif.). The solids content and the average particle size (VₘₑₐₙPS) of the solids particles of the dispersion are indicated in Table 2B.

TABLE 1
Raw Materials for Polyolefin Dispersions

| | | | Melting | Melt | Density | Acid |
|---|---|---|---|---|---|---|
| Material | Composition | Function | Point (° C.) | Index * | (g/cm³) | Value |
| HDPE DMDA 8940 | High density polyethylene | Base Polymer | 128 | 44 | 0.951 | n/a |
| HDPE DMDA 8965 | High density polyethylene | Base Polymer | 128 | 66 | 0.954 | n/a |
| HDPE DGDA 2420 | High density polyethylene | Base Polymer | ~130 | >0.28 | 0.940 | n/a |
| 6D43 polypropylene | Polypropylene copolymer | Base Polymer | 145 | 35^{a} | 0.9 | n/a |
| PRIMACOR ™ 5980i | Ethylene acrylic acid | Dispersing | 77.2 | 300 | 0.958 | 154 |
| | copolymer (20% AA) | agent | | | | |
| Unicid ™350 | (80/20) Long chain linear | Dispersing | 92 | Wax | 0.9 | 120 |
| | primary carboxylic | agent | | | | |
| | acid/polyethylene | | | | | |
| Licocene ™PE MA | Maleic anhydride | Modifying | 123 | Wax | 0.99 | 45 |
| 4351 | modified PE wax | polymer | | | | |
| Licocene 6452 | Maleic anhydride | Modifying | 140 | wax | 0.91 | 41 |
| | modified PP wax | polymer | | | | |
| Honeywell AC575 | Maleic anhydride | Modifying | 106 | wax | 0.92 | 35 |
| | modified PE wax | polymer | | | | |
| AMPLIFY GR204 | Maleic anhydride grafted | Modifying | 127 | 12 | 0.954 | ~8 |
| | polyethylene | Polymer | | | | |
| DMEA | Dimethyethanolamine | Neutralizing | n/a | n/a | n/a | n/a |
| | | agent | | | | |

* Melt index conditions for PP based materials are 230° C./2.16 kg and for PE based materials are 190° C./2.16 kg.

TABLE 2A
Composition and Process Conditions for Dispersions

| | | | | | | Dilution |
|---|---|---|---|---|---|---|
| | | | | | Base/ | Water |
| | Component 1 | Component 2 | Component 3 | Initial Water | Surfactant | 1^{st}/2^{nd} |
| | (feed rate | (feed rate | (feed rate | (feed rate | (feed rate | (feed rate |
| Example | in g/min) | in g/min) | in g/min) | in g/min) | in g/min) | in g/min) |
| (A) | HDPE DMDA 8940 | Licocene 4351 | Unicid 350 | (38.8) | DMEA | 240/120 |
| | (235.9) | (45.4) | (21.2) | | (12.6) | |
| (B) | DGDA 2420 | Licocene 4351 | PRIMACOR 5980i | (37.4) | DMEA | 130/0 |
| | (47.6) | (5.3) | (22.7) | | (11.9) | |
| (C) | HDPE DMDA 8940 | Amplify GR 204 | PRIMACOR 5980i | (66.6) | DMEA | 240/120 |
| | (204) | (9) | (66) | | (27.9) | |
| | | Licocene 4351 | | | | |
| | | (21) | | | | |
| (D) | 6D43 PP | Licocene 6452 | PRIMACOR 5980i | (14.3) | DMEA | 83/0 |
| | (52.9) | (5.7) | (17.0) | | (6.4) | |
| [E] | HDPE DMDA 8965 | n/a | PRIMACOR 5980i | (37.9) | (8.9) | 120/0 |
| | (53) | | (22.7) | | | |

TABLE 2B
Composition and Process Conditions for Dispersions (cont'd)

| | Extruder | | | | | |
|---|---|---|---|---|---|---|
| | Temperature | | | | | Viscos- |
| | in Polymer | Extruder | | Vₘₑₐₙ | | ity, cP |
| | Melt Zone | Speed | % | P.S. | | (Rv3, |
| Example | (° C.) | (rpm) | Solids | (microns) | pH | 50 rpm) |
| (A) | 160 | 1200 | | 0.6 | | |
| (B) | 190 | 470 | | 34 | | |
| (C) | 160 | 1200 | 45.5% | 0.7 | 9.9 | 838 |
| (D) | 170 | 470 | 49.7% | 0.9 | 9.8 | 910 |
| [E] | 160 | 1200 | 34.9% | 1.4 | | |

### EXAMPLE 2

### Flexible Impregnated Article and Composites

### Unicid Based HDPE DMDA 8940 Based CIPP Flexible Impregnated Article and Composite

### Example #1

5 cm×5 cm (25 cm²) squares of CIPP liner/fabric were coated with HDPE dispersion (Example A). Three coating levels were used, 0.14 g/cm² wet (barely wetting the fabric, liquid level not quite up to height of fabric tufts), 0.18 g/cm² (completely wetting the fabric, liquid height at level of fabric tufts), and 0.26 g/cm² (over-wetting the fabric, liquid level above the level of most of the tufts). The dispersion wetted CIPP fabric was dried overnight in a convection oven at 60° C., below the melting temperature of any of the solid ingredients in dispersion Example A. When dried, these fabrics were flexible, and did not slough any solid material when bent back upon themselves with an approximately 2 cm radius in either direction. After these dried samples were heated to 140° C. for two hours to coalesce the base resin they became rigid and could not be bent.

The plastic backing of the CIPP liner/fabric also appeared to have melted (change in color, shrinkage), 5 cm×5 cm square without an added dispersion was also heated in the oven at 140° C. to determine what impact the plastic had to the post melting property improvement. This piece remained flexible after removal from the oven and cooling, similar to the original liner/fabric, even though the backing shrank.

### PRIMACOR Based DMDA 8940 HDPE Flexible Impregnated Article and Composite

### Example #2

5 cm×5 cm (25 cm²) squares of CIPP liner/fabric were coated with PRIMACOR based HDPE dispersion (Example C). Two samples were made up at one coating level of 0.2 g/cm², which over-wets the fabric, with the liquid level above the level of most of the tufts. The dispersion wetted CIPP fabric was dried for either 2 hours or overnight in a convection oven at 60° C., below the melting temperature of any of the solid ingredients in dispersion C from Tables 2A-2B. When dried, these fabrics were somewhat flexible, although not as flexible as the Unicid based dispersion samples. The grade of HDPE was DMDA 8940 for both these samples. We were able to get about 45° C. of flex across a 5 cm sample when the material was dried overnight at 60° C., and 90° C. of flex when the material was dried for 2 hours at 60° C. as opposed to 180° C. of flex with the UNICD based article. There was still no slough of solid material in either case. After these dried samples were heated to 140° C. for two hours to coalesce the base resin, they became rigid and could not be bent.

### PRIMACOR Based DGDA 2420 HDPE Flexible Impregnated Article and Composite

### Example #3

5 cm×5 cm (25 cm²) squares of CIPP liner/fabric were coated with PRIMACOR based DGDA 2420 HDPE dispersion (Example B). Two samples were made up at one coating level of 0.2 g/cm², which over-wets the fabric, with the liquid level above the level of most of the tufts. The dispersion wetted CIPP fabric was dried for two hours in a convection oven at 60° C., below the melting temperature of any of the solid ingredients in dispersion Example B. When dried, these fabrics were somewhat flexible, we were able to get about 90° C. of flex across a 5 cm sample as opposed to 180° C. of flex with the UNICD based article. There was still no slough of solid material. After these dried samples were heated to 140° C. for two hours to coalesce the base resin, they became rigid and could not be bent.

### PRIMACOR Based 6D43 Polypropylene Flexible Impregnated Article and Composite

### Example #4

5 cm×5 cm (25 cm²) squares of CIPP liner/fabric were coated with PRIMACOR based 6D43 polypropylene dispersion (Example D). Two samples were made up at one coating level of 0.2 g/cm², which over-wets the fabric, with the liquid level above the level of most of the tufts. The dispersion wetted CIPP fabric was dried for two hours in a convection oven at 60° C., below the melting temperature of any of the solid ingredients in dispersion Example D. When dried, these fabrics were somewhat flexible, we were able to get about 90° C. of flex across a 5 cm sample. There was still no slough of solid material. After these dried samples were heated to 150° C. for two hours to coalesce the base resin, they became rigid and could not be bent.

### PRIMACOR ONLY Based DMDA 8965 HDPE Flexible Impregnated Article and Composite

### Example #5

5 cm×5 cm (25 cm²) squares of CIPP liner/fabric were coated with PRIMACOR ONLY based HDPE dispersion (Example E). Two samples were made up at one coating level of 0.2 g/cm², which over-wets the fabric, with the liquid level above the level of most of the tufts. The dispersion wetted CIPP fabric was dried for 2 hours in a convection oven at 60° C., below the melting temperature of any of the solid ingredients in dispersion Example E. When dried, these fabrics were flexible, and could be bent to 180° C. across the 5 cm sample. There was slough of solid material from the dried sample. After the dried sample was heated to 140° C. for two hours to coalesce the base resin, it became rigid and could not be bent.

### HDPE Based Conventional Composite

13 cm×13 cm squares of 3M fiberglass (Bondo®, 3M) were coated with HDPE dispersion (Control 1). Two coating methods were used: full immersion (over-wetting the fabric), and brushed-on (completely wetting the fabric). The dispersion wetted fiberglass squares were dried overnight in a convection oven at 80° C., below the melting temperature of the dispersion's solid components. When dry, these fabrics were flexible and only the over-wetted specimens sloughed off excess material after being bent back upon themselves. These samples were then heated in a Carver press (166 MPa) at 150° C. for 1, 5, or 10 minutes. The heated samples remained flexible and did not break when bent back upon themselves.

### EXAMPLE 3

### Mechanical Testing of Flexible Impregnated Article and Composites

The flexural modulus of the dispersion modified (dried and coalesced) and neat CIPP fabric was measured with a RSA3 dynamic mechanical analyzer from TA instruments operating in a three point bend geometry. The span of the two supports was 25 mm. The composite parts were cut with an air press and die to a width of 12.5 mm. The composite parts (CIPP backing plus polymer impregnated felt) were 3.14 mm thick. The flexural modulus results measured from this test are based on the entire thickness (3.14 mm) that includes the physical properties of the flexible backing. The test was run at a rate of 1 rad/sec and a strain of 0.04%. Before each test the samples were preloaded to ˜70 g of force. The flexural modulus results reported in Table 3 are averages of no less than three individual measurements. The orientation of the CIPP fabric (olefin impregnated felt side up or backing side up) did not influence the flexural modulus result.

TABLE 3
Flexural Modulus Testing Results

| | | | Flex Mod |
|---|---|---|---|
| | | Flex Mod | (multiple of |
| | Flex Mod | (% of base | unmodified |
| Sample | (psi) | resin) | CIPP) |
| Unmodified CIPP (control) | 6004 | n/a | 1x |
| 6D43 PP (control) | 120000 | 100% | 20x |
| Dried 6D43 PP/Primacor (Ex. 4, | 10413 | 8.7% | 1.7x |
| Dispersion D) | | | |
| Coalesced 6D43/Primacor (Ex. 4, | 43076 | 35.3% | 7.2x |
| Dispersion D) | | | |
| DMDA 8940 (control) | 148000 | 100% | 24x |
| Dried DMDA 8940/Unicid (Ex. 1, | 8006 | 5.4% | 1.3x |
| Dispersion A) | | | |
| Coalesced DMDA 8940/Unicid | 58161 | 39.3% | 9.7x |
| (Ex. 1, Dispersion A) | | | |
| Dried DMDA 8940/Primacor | 13184 | 8.9% | 2.2x |
| (Ex. 2, Dispersion C) | | | |
| Coalesced DMDA 8940/Primacor | 43076 | 29.1% | 7.2x |
| (Ex. 2, Dispersion C) | | | |
| DGDA 2420 (control) | >90000 | 100% | 15x |
| Dried DGDA 2420/Primacor | 9572 | 10.6% | 1.6x |
| (Ex. 3, Dispersion B) | | | |
| Coalesced DGDA 2420/Primacor | 37855 | 42.1% | 6.3x |
| (Ex. 3, Dispersion B) | | | |
| DMDA 8965 (control) | 145000 | 100% | 24x |
| Dried DMDA 8965/Primacor | 10306 | 7.11% | 1.7x |
| ONLY (Ex. 5, Dispersion E) | | | |
| Coalesced DMDA 8965/Primacor | 24294 | 16.75% | 4.0x |
| ONLY (Ex. 5, Dispersion E) | | | |

1. A flexible impregnated article comprising:
a fabric material comprising a thermoplastic backing layer and a fibrous layer impregnated with an aqueous dispersion, wherein the aqueous dispersion comprises:
(a) a base resin comprising at least one C₂-C₃ polyolefin having a melting point of at least 110° C.; and
(b) a dispersing agent comprising at least one of a polymer having ethylene and carboxylic acid, a modifying polymer comprising at least one maleated C₂-C₃ polyolefin wax, or combinations thereof;
wherein the flexible impregnated article has a flexural modulus of less than 15,000 psi.

2. The flexible impregnated article of claim 1, wherein the aqueous dispersion comprises the dispersing agent comprising at least one polymer having ethylene and carboxylic acid.

3. The flexible impregnated article of claim 1, wherein the flexible impregnated article is substantially free of epoxy and carbamide material.

4. The flexible impregnated article of claim 1, wherein the base resin comprises one or more components selected from the group consisting of polyethylene copolymers having a density above about 0.930 g/cm³, polypropylene copolymers, or combinations thereof.

5. The flexible impregnated article of claim 1, wherein the dispersing agent has a melting point less than 100° C.

6. The flexible impregnated article of claim 1, wherein the base resin comprises polypropylene.

7. The flexible impregnated article of claim 1, wherein the thermoplastic backing layer comprises one or more components selected from the group consisting of polyethylene copolymers having a density above about 0.930 g/cm³, polypropylene copolymers, or combinations thereof.

8. The flexible impregnated article of claim 1, wherein aqueous dispersion is impregnated into the fibrous layer at a coat weight of less than 0.3 g/cm² of fibrous material.

9. The flexible impregnated article of claim 1, wherein the fibrous layer comprises polyester.

10. The flexible impregnated article of claim 1, wherein the fibrous layer comprises prepreg fiber.

11. A composite produced by heating a flexible impregnated article, the flexible impregnated article comprising:
a fabric material comprising a thermoplastic backing layer and a fibrous layer impregnated with an aqueous dispersion, wherein the aqueous dispersion comprises:
(a) a base resin comprising at least one C₂-C₃ polyolefin having a melting point of at least 110° C.; and
(b) a dispersing agent comprising at least one polymer having ethylene and carboxylic acid or a modifying polymer comprising at least one maleated C₂-C₃ polyolefin wax, and combinations;
wherein the flexible impregnated article is heated above the melting temperature of the base resin of the aqueous dispersion, and the flexible impregnated article has a flexural modulus of less than 15,000 psi.

12. The composite of claim 11, wherein the aqueous dispersion comprises the dispersing agent comprising at least one polymer having ethylene and carboxylic acid.

13. The composite of claim 11, wherein the composite has a flexural modulus at least 2.3 times the flexural modulus of the flexible impregnated article.

14. A process of forming flexible impregnated article, comprising: providing a fabric material comprising a thermoplastic backing layer and a fibrous layer; exposing the fabric material to an aqueous dispersion; and drying the aqueous dispersion to impregnate the fibrous layer; wherein the aqueous dispersion comprises:
(a) a base resin comprising at least one C₂-C₃ polyolefin having a melting point of at least 110° C.; and
(b) a dispersing agent comprising at least one polymer having ethylene and carboxylic acid or a modifying polymer comprising at least one maleated C₂-C₃ polyolefin wax, and combinations.

15. The process of claim 14, wherein the aqueous dispersion comprises the dispersing agent comprising at least one polymer having ethylene and carboxylic acid.

16. The process of claim 14, wherein the drying step comprises applying an elevated temperature that is less than a minimum film forming temperature of the base resin, modifying polymer, and dispersing agent of the aqueous dispersion.
